(19) United States
(12) Patent Application Publication
(10) Pub. No.: US 2015/0317419 A1
(43) Pub. Date: Nov. 5, 2015

(54) LOCAL DIRECT SAMPLING METHOD FOR CONDITIONING AN EXISTING RESERVOIR MODEL

(71) Applicant: CONOCOPHILLIPS COMPANY, Houston, TX (US)

(72) Inventors: Cheolkyun JEONG, Houston, TX (US); Lin Ying HU, Houston, TX (US); Yongshe LIU, Houston, TX (US)

(21) Appl. No.: 14/700,617

(22) Filed: Apr. 30, 2015

Related U.S. Application Data
(60) Provisional application No. 61/987,199, filed on May 1, 2014.

(51) Int. Cl. G06F 17/50; G06N 99/00; G06F 17/18

(52) U.S. Cl. CPC G06F 17/5009; G06F 17/18; G06N 99/005

(57) ABSTRACT

A method of computer modeling a reservoir using multiple-point statistics from non-stationary training images is provided. Some methods include: a) identifying a path via a computer processing machine to visit all nodes of a simulation field; b) setting a template for searching data event in the simulation field and for searching data event replicates in the non-stationary training image; c) defining a neighborhood in which the training image is sampled; d) formulating a kernel function that g_{σ}(d) that decreases from 1 to 0 when distance d increases from 0 to infinity; e) for the current node in the simulation filed, identifying the data event covered by the template; f) randomly sampling the training image in the neighborhood of corresponding node in the training image until an exact or approximate replicate of the data event is found; g) computing distance d between central node of the replicate and simulation node; h) computing the kernel function; i) drawing a random number u between 0 and 1; j) assigning value of central node of the replicate to the simulation node if g_{σ}(d) is greater than u; k) repeating steps f) to j) if g_{σ}(d) is not greater than u; and repeating steps e) to k) until all simulation nodes are visited

### CROSS-REFERENCE TO RELATED APPLICATIONS

This application is a non-provisional application which claims benefit under 35 USC §119(e) to U.S. Provisional Application Ser. No. 61/987,199 filed May 1, 2014, entitled “LOCAL DIRECT SAMPLING METHOD OF CONDITIONING AN EXISTING RESERVOIR MODEL,” which is incorporated herein in its entirety.

### FIELD OF THE INVENTION

The present invention relates generally to computer-simulated reservoir modeling. More particularly, but not by way of limitation, embodiments of the present invention include tools and methods for implementing local direct sampling in multiple-point simulation.

### BACKGROUND OF THE INVENTION

Geostatistical methods have been increasingly used in the petroleum industry for modeling geological and petrophysical heterogeneities of hydrocarbon reservoirs. One of the reasons for this increased usage is that reservoir models derived from geostatistics are useful for reservoir simulations and reservoir managements. Reservoir modeling is a computer simulation technique that can be used to estimate hydrocarbon reserve levels and optimize its recovery. The technique can be used to generate a 2D or 3D model of a reservoir that represents key physical attributes such as geological properties, fluid flow, and the like. Some advanced reservoir modeling techniques use geostatistical approaches employing two-points and multiple-points (“multipoint”) statistics to generate the simulated models.

In the last two decades, multiple-point (MP) geostatistics has been developed for modeling subsurface heterogeneity (Guardiano and Srivastava, 1993; Strebelle, 2000; Hu and Chugunova, 2008). Unlike traditional geostatistical simulations based on random function models, a multiple-point simulation (MPS) does not require explicit definition of a random function. Instead, it directly utilizes empirical multivariate distributions inferred from one or more training images (TI's). This approach can also be flexible to data conditioning as well as represent complex architectures of geological facies and petrophysical properties.

MPS can be used to describe complex geological features of petroleum reservoirs. In general, MPS method is based on multiple-point statistics derived from training images that represent geological patterns (features) of reservoir heterogeneity. Traditional MPS methods typically require the training images to be stationary in space despite the fact that spatial distribution of geological patterns/features is usually non-stationary. This means that the training image, being stationary, bears no information about location of the geometrical patterns/features of heterogeneity in either the reservoir itself or in a model realization.

Real geological patterns often present spatial trends and are not stationary in the sense described above. Normally, a geologist will need to create a training image prior to a model being created. Creating a realistic, but stationary training image is a difficult task because a realistic training image cannot be stationary in most real world situations. Methods have been developed to integrate spatial trends into MPS realizations (see, e.g. Strebelle and Zhang, 2005), but these method still use stationary training image.

Some MPS methods have been developed which utilize non-stationary training images. For example, Chugunova and Hu (2008) describe a method in which coupled primary and secondary training images are used to infer conditional probability of a primary variable given a primary pattern and a secondary datum. This method can be applied to the case where a secondary data set (e.g., from seismic) is available for constraining the spatial distribution of geological patterns. Although realistic MPS models are constructed by using this method, the basic algorithm remains heuristic. This method also requires building a secondary training image from the primary training image in consistency with the secondary data. Besides, the non-stationary TI's of the above MPS method do not necessarily reflect the location of the geometrical patterns/features of the reservoir heterogeneity. Therefore, they can be far from being a realistic reservoir model.

### BRIEF SUMMARY OF THE DISCLOSURE

The present invention relates generally to computer-simulated reservoir modeling. More particularly, but not by way of limitation, embodiments of the present invention include tools and methods for implementing local direct sampling in multiple-point simulation.

One example of a multiple-point simulation method with non-stationary training image includes: a) identifying a path via a computer processing machine to visit all nodes of a simulation field; b) setting a template for searching data event in the simulation field and for searching data event replicates in the non-stationary training image; c) defining a neighborhood in which the training image is sampled; d) formulating a kernel function that g_{σ}(d) that decreases from 1 to 0 when distance d increases from 0 to infinity; e) for the current node in the simulation field, identifying the data event covered by the template; f) randomly sampling the training image in the neighborhood of corresponding node in the training image until an exact or approximate replicate of the data event is found; g) computing distance d between central node of the replicate and simulation node; h) computing the kernel function; i) drawing a random number u between 0 and 1; j) assigning value of central node of the replicate to the simulation node if g_{σ}(d) is greater than u; k) repeating steps f) to j) if g_{σ}(d) is not greater than u; and repeating steps e) to k) until all simulation nodes are visited and simulated.

### BRIEF DESCRIPTION OF THE DRAWINGS

A more complete understanding of the present invention and benefits thereof may be acquired by referring to the follow description taken in conjunction with the accompanying drawings in which:

FIGS. 1A-1C illustrate an embodiment of the present invention as described in the Example.

FIG. 2 illustrates an embodiment of the present invention as described in the Example.

FIG. 3A-3D illustrate an embodiment of the present invention as described in the Example.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations that come within the scope of the invention.

The present invention provides a multiple-point simulation method with non-stationary training images using local direct sampling. Previously, US Publication No. 20130110484 (the relevant parts of which are hereby incorporated by reference) proposed a mathematically consistent solution for building MPS models using non-stationary training images using a data structure (search tree) to store statistics and location of patterns. Prior to this, MPS models typically did not incorporate non-stationary training images. While this MPS method with non-stationary TI provides a more realistic geological model (as compared to methods using stationary training images), utilization of a search tree can be computationally (e.g., central processing unit and memory) intensive as these MPS methods store all possible data-events in the search tree which creates memory storage issues. This is particularly problematic in big reservoir models having in excess of million cells.

In some embodiments, the present invention extends the usefulness of MPS method with non-stationary TI by improving its computational efficiency. This may be accomplished, at least in part, by modifying the MPS with non-stationary TI method by replacing search tree with direct sampling. In local direct sampling, the training image may be scanned for each simulation node. Without being limited by theory, patterns beyond the neighborhood of the simulation node have negligible influence on the simulation result, making it possible to scan the training image only in the neighborhood of the simulation node. This makes the MPS using non-stationary TI method without a search tree (MPS with direct sampling) both possible and practical.

In some embodiments, MPS with local direct sampling can be applied to cases where reservoir models exist and may need to be conditioned to data. The non-stationary training image utilized in the MPS with local direct sampling can be derived from geologic-process-based model or any other compatible model.

Some methods for implementing multiple-point simulation with non-stationary training images using local direct sampling include:
a) identifying a path via a computer processing machine to visit all nodes of a simulation field;
b) setting a template for searching data event in the simulation field and for searching data event replicates in the training image;
c) defining a neighborhood in which the training image is sampled;
d) formulating a kernel function g_{σ}(d) that decreases from 1 to 0 when d increases from 0 to infinity (e.g., a Gaussian kernel function g_{σ6}(d)=exp (−d²/2σ²);
e) for each node in the simulation field
   1) identifying the data event covered by the template in the simulation field;
   2) randomly sampling the training image in the neighborhood of the corresponding node in the training image until an exact or approximate replicate of the data event is found;
   3) computing the distance d between the central node of the replicate and the simulation node, and computing the kernel function g_{σ}(d);
   4) drawing a uniform random number u between 0 and 1;
   5) assigning value of the central node of the replicate to the simulation node if g_{σ}(d) is greater than u; otherwise, repeating from step 2.
f) repeating step e) until all nodes are simulated.

The term “simulation grid” means an unpopulated or partially populated grid of cells which, when fully populated with data, becomes a model realization. In some embodiments, the methods of the present invention can be extended by using multi-grids, regular or mixed simulation path etc. This can further improve the quality of MPS simulation.

Local direct sampling can avoid scanning the entire training image for simulating each node, thus gaining computation efficiency. In addition, both random and local sampling of the training image make the local direct sampling algorithm more efficient than traditional MPS methods with search trees. The local sampling feature accounts for the non-stationarity while also improving the efficiency of the direct sampling method. The method can be computationally efficient in many cases including process-based models and any other type of existing models.

### EXAMPLE

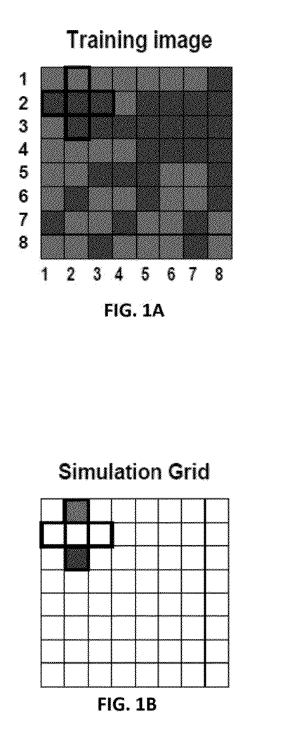

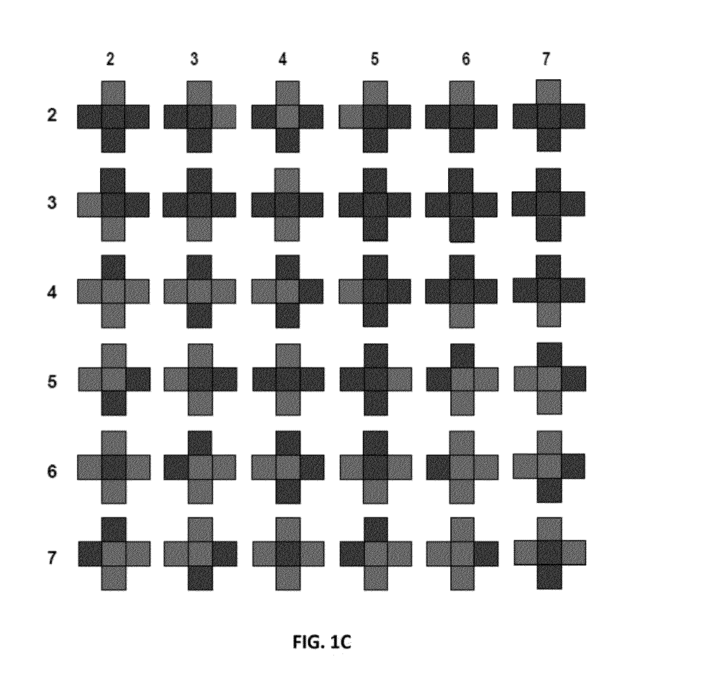

This Example illustrates the concept of location-dependent sampling of patterns from a non-stationary TI according to one or more embodiments of the present invention. FIGS. 1A-1C illustrate location-dependent patterns in a simple training image having two colors (light and dark). As shown in FIG. 1A, the training image is divided into an 8 cells by 8 cells grid. Each cell (or simulation node) of the TI grid is represented by a color. The TI grid can be scanned by a template that include a central cell and 4 neighboring cells (see dark black lines in FIG. 1A). FIG. 1B illustrates the simulation grid with a data event at the top left corner, which has two cells with colors assigned. FIG. 1C shows a matrix of patterns from the TI, each pattern includes a center cell corresponding to an x-y axis location and its 4 neighboring cells (bold lines in FIG. 1A).

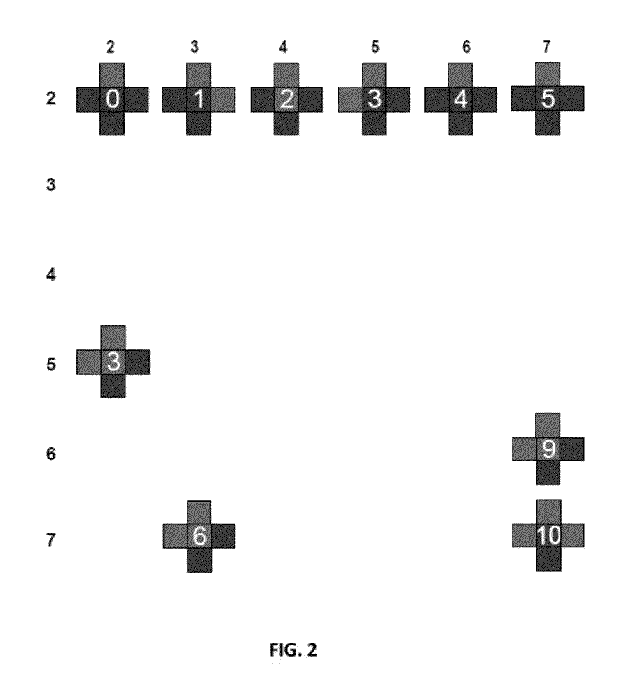

FIG. 2 shows all the patterns in the TI grid compatible with the data event in the simulation grid, and their distances from the central node of the data event. In this view, the number in the central node of a pattern in the TI grid is the distance between this pattern and the central node of the data event at the top left corner. As shown in FIG. 2, pattern (2,3) is 1 distance unit away from the data event at (2,2) while pattern (2,6) is 4 distance unit away from the data event at (2,2).

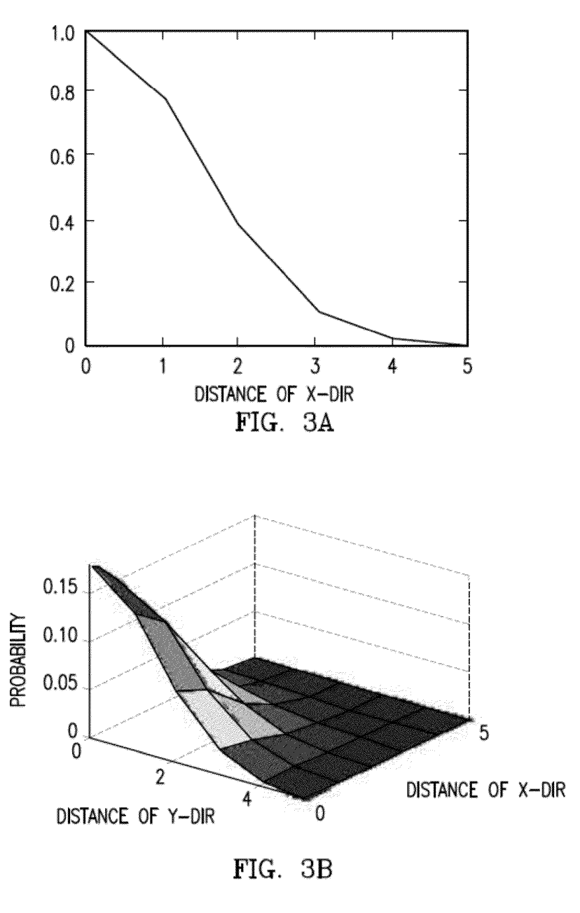

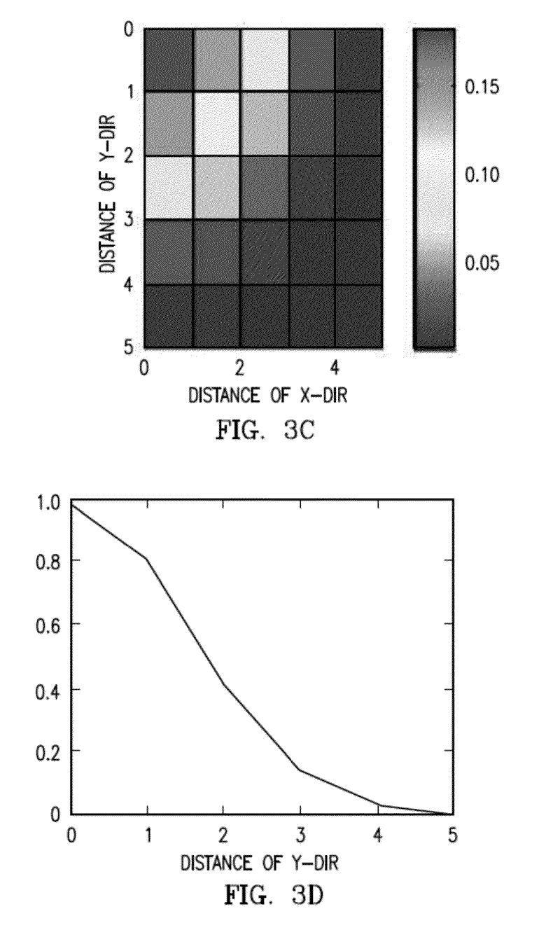

FIGS. 3A-3D show an example of the kernel function according to one or more embodiments of the present invention. FIG. 3A plots a kernel function that decreases from 1 to 0 when the distance increases away from the node from 0 to infinity along X-axis direction. FIG. 3D shows a similar kernel function as distance increases along Y-axis direction.

FIG. 3B is a 3-D view of a kernel function showing the probability of selecting a pattern decreases when its distance from the data event increases. FIG. 3C is a 2-D representation of FIG. 3B.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

### REFERENCES

All of the references cited herein are expressly incorporated by reference. The discussion of any reference is not an admission that it is prior art to the present invention, especially any reference that may have a publication data after the priority date of this application. Incorporated references are listed again here for convenience:
1. U.S. 20110251833
2. U.S. 20130110484

1. A method for computer modeling a reservoir using multiple-point statistics from non-stationary training images, comprising:
a) identifying a path via a computer processing machine to visit all nodes of a simulation field;
b) setting a template for searching data event in the simulation field and for searching data event replicates in the non-stationary training image;
c) defining a neighborhood in which the training image is sampled;
d) formulating a kernel function that g_{σ}(d) that decreases from 1 to 0 when distance d increases from 0 to infinity;
e) for the current node in the simulation field, identifying the data event covered by the template;
f) randomly sampling the training image in the neighborhood of corresponding node in the training image until an exact or approximate replicate of the data event is found;
g) computing d between central node of the replicate and simulation node;
h) computing the kernel function;
i) drawing a random number u between 0 and 1;
j) assigning value of central node of the replicate to the simulation node if g_{σ}(d) is greater than u; and
k) repeating steps f) to j) if g_{σ}(d) is not greater than u.

2. The method of claim 1 further comprising:
repeating steps e) to k) until all simulation nodes are visited and simulated.

3. The method of claim 1, wherein g_{σ}(d) is a Gaussian kernel function defined as g_{σ}(d)=exp (−d²/2σ²).

4. The method of claim 1 wherein the non-stationary training image is generated from a process-based model.

5. The method of claim 1 wherein the non-stationary training image is an existing model.

6. A method for computer modeling a reservoir using multiple-point statistics from non-stationary training images, comprising:
a) identifying a path via a computer processing machine to visit all nodes of a simulation field;
b) setting a template for searching data event in the simulation field and for searching data event replicates in the non-stationary training image;
c) defining a neighborhood in which the training image is sampled;
d) formulating a kernel function that g_{σ}(d) that decreases from 1 to 0 when distance d increases from 0 to infinity;
e) for the current node in the simulation field, identifying the data event covered by the template;
f) randomly sampling the training image in the neighborhood of corresponding node in the training image until an exact or approximate replicate of the data event is found;
g) computing d between central node of the replicate and simulation node;
h) computing the kernel function;
i) drawing a random number u between 0 and 1;
j) assigning value of central node of the replicate to the simulation node if g_{σ}(d) is greater than u; and
k) repeating steps f) to j) if g_{σ}(d) is not greater than u.
l) repeating steps e) to k) until all simulation nodes are visited and simulated.

7. The method of claim 6, wherein g_{σ}(d) is a Gaussian kernel function defined as g_{σ}(d)=exp (−d²/2σ²).

8. The method of claim 6 wherein the non-stationary training image is generated from a process-based model.

9. The method of claim 6 wherein the non-stationary training image is an existing model.

10. A method for computer modeling a reservoir using multiple-point statistics from non-stationary training images, comprising:
a) identifying a path via a computer processing machine to visit all nodes of a simulation field;
b) setting a template for searching data event in the simulation field and for searching data event replicates in the non-stationary training image;
c) defining a neighborhood in which the training image is sampled;
d) formulating a kernel function that g_{σ}(d) that decreases from 1 to 0 when distance d increases from 0 to infinity, wherein g_{σ}(d) is a Gaussian kernel function defined as g_{σ}(d)=exp (−d²/2σ²);
e) for the current node in the simulation field, identifying the data event covered by the template;
f) randomly sampling the training image in the neighborhood of corresponding node in the training image until an exact or approximate replicate of the data event is found;
g) computing d between central node of the replicate and simulation node;
h) computing the kernel function;
i) drawing a random number u between 0 and 1;
j) assigning value of central node of the replicate to the simulation node if g_{σ}(d) is greater than u; and
k) repeating steps f) to j) if g_{σ}(d) is not greater than u.

11. The method of claim 10 further comprising:
repeating steps e) to k) until all simulation nodes are visited and simulated.

12. The method of claim 10, wherein the non-stationary training image is generated from a process-based model.

13. The method of claim 10 wherein the non-stationary training image is an existing model.
